(19) United States
(12) Patent Application Publication
(10) Pub. No.: US 2026/0064595 A1
(43) Pub. Date: Mar. 5, 2026

(54) Adaptive Caching Of Memory Request Streams

(71) Applicant: Google LLC, Mountain View, CA (US)

(72) Inventors: Lijun Li, Mountain View, CA (US); Pavan Thirunagari, Mountain View, CA (US); Xiaoping Xie, Cupertino, CA (US); En-Chih Chang, Mountain View, CA (US)

(21) Appl. No.: 19/105,957

(22) PCT Filed: Aug. 26, 2022
(86) PCT No.: PCT/US2022/041725

§ 371 Date: Feb. 24, 2025

(51) Int. Cl. G06F 12/084; G06F 12/0842; G06F 12/0855

(52) U.S. Cl. CPC G06F 12/084; G06F 12/0842; G06F 12/0857; G06F 2212/1021

(57) ABSTRACT

Methods, systems, and apparatus, including computer programs encoded on computer storage media, for allocating cache resources according to stream ids. One of the methods includes caching memory requests for each of the one or more integrated client devices, distinguishing different computing tasks using stream ids of the memory requests, and allocating different partitions of the cache memory to different respective computing tasks.

### BACKGROUND

This specification is related to systems containing integrated circuit devices.

Caches are auxiliary devices that manage data traffic to memory. A cache interacts with one or more hardware devices in a system to store data retrieved from memory, or store data that is to be written to memory, or both. The hardware devices can be various components of an integrated circuit and be implemented into a system on a chip (SOC). Devices that supply read and write requests through caches, or directly to memory, will be referred to as client devices.

A cache is frequently utilized to reduce power consumption by limiting the total number of requests to main memory. Further power savings can be achieved by placing the main memory and the data pathways to main memory in a lowered power state. Due to the inverse correlation between cache usage and power consumption, maximizing cache usage leads to an overall decrease in power consumed. The power capacity of battery powered devices, e.g., mobile computing devices, can be spent more efficiently by increasing cache usage of integrated client devices. Moreover, accessing the cache is generally faster than accessing the main memory, thereby increasing the performance of the integrated client devices.

Caches are commonly organized into partitions to increase cache usage. A partition represents a portion of the cache that is allocated for a particular purpose or to a particular entity, e.g., to a particular client device. However, effective cache partitioning and stream allocation can be challenging due to the limited size of the partitions with respect to the working data set of the system, e.g., mobile computing devices, as well as the way that memory needs shift over time. Cache thrashing can occur when memory requests of client devices compete for the same resources in their respective partitions and thus diminishes cache usage. In these cases, system operations can fail to progress, thereby degrading system performance and increasing power consumption. Maximizing cache usage therefore relies on optimizing stream allocation to cache partitions.

### SUMMARY

This specification describes techniques for implementing a caching policy in a cache that is driven by correlated streams of data, referred to as “computing tasks”, herein. In this specification, a computing task can be associated with a plurality of memory requests that are related to each other in software. For example, computing tasks can include all requests for data or all requests for instructions for a client device (or software driver). Depending on a particular workload of a client device, the device may perform multiple computing tasks sequentially or in parallel that each include numerous related memory requests.

A cache can identify computing tasks by inspecting stream ids that different memory requests have in common. The cache can then allocate different partitions of the cache memory to different tasks by referencing their respective stream ids. Therefore, for example, requests for instructions can be allocated to different partitions of the cache than requests for data. Moreover, the cache can adaptively allocate computing tasks based on the corresponding hit metrics of each partition. This capability allows a cache to self-tune to an optimal allocation of computing tasks that maximizes cache performance.

Particular embodiments of the subject matter described in this specification can be implemented so as to realize one or more of the following advantages. A cache can increase the performance and utilization of the cache by using stream ids to determine related computing tasks. Therefore, the cache can reduce competition for cache resources for different computing tasks, which increases the cache hit rate. Increasing the cache hit rate decreases power consumption and extends battery life in mobile devices that rely on battery power. The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system.

FIG. 2 is a diagram of an example subsystem.

FIG. 3 is a flowchart of an example process for allocating partitions in a cache.

FIG. 4 is a flowchart of an example process for servicing a memory request using partitions of a cache dedicated to computing tasks.

FIG. 5 is a flowchart of an example process for adaptively allocating computing tasks to partitions of a cache.

Like reference numbers and designations in the various drawings indicate like elements.

### DETAILED DESCRIPTION

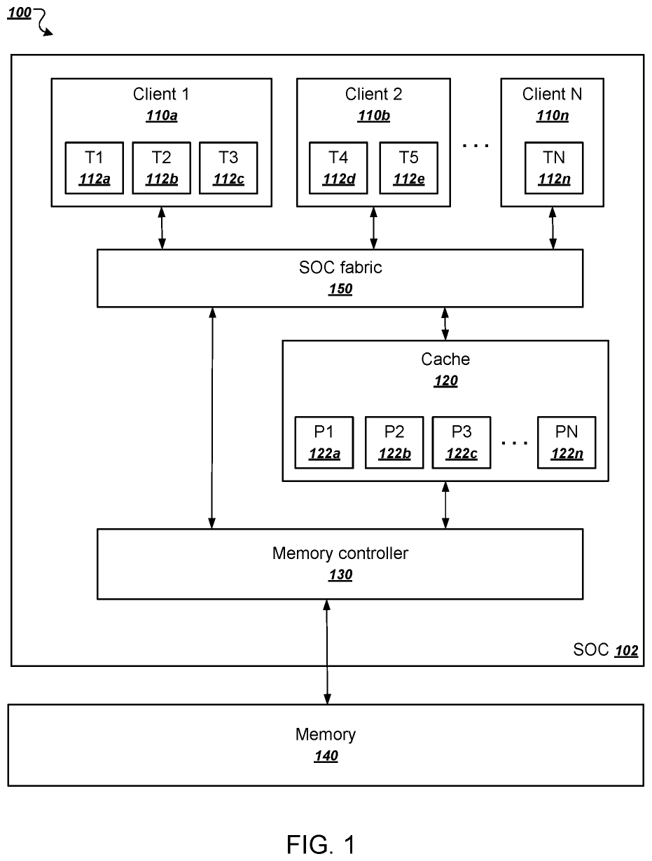

FIG. 1 is a diagram of an example system 100. The system 100 includes a number of client devices 110a, 110b, through 110n that provide memory requests for locations in a memory device 140. The aforementioned components can be integrated onto a single system on a chip (SOC) 102. The memory controller 130 can handle data requests to and from the memory device 140 of the system 100. The cache 120 caches data requests for multiple client devices on the SOC 102, and thus, the cache 120 may be referred to as a system-level cache (SLC). However, the techniques described below can be utilized for various types of devices that perform caching of memory requests. For example, caches that cache memory requests for only a single client device or software driver, or for client devices that are not integrated on the same SOC 102 as the cache 120.

The SOC 102 is an example of a device that can be installed on or integrated into any appropriate computing device, which may be referred to as a host device. Because the techniques described in this specification are particularly suited to reducing power consumption and increasing performance for the host device, the SOC 102 can be especially beneficial when installed on mobile host devices that rely on battery power, e.g., a smart phone, a smart watch or another wearable computing device, a tablet computer, or a laptop computer, to name just a few examples.

The SLC 120 is an example of a cache that can be partitioned. Partitions 112a-n are portions, e.g., ways or sets, in the cache that are allocated to memory requests having one or more attributes.

Multiple client devices 110a-n are integrated on the SOC 102. Each of the client devices 110a-n can be a suitable module, device, or functional component that is configured to communicate memory requests to the cache 120 and memory controller 130 through the SOC fabric 150. For example, a client device 110a-n, or the SOC 102 itself, can be a central processing unit (CPU), a graphics processing unit (GPU), a tensor processing unit (TPU), an ambient computing module, an image processor, a sensor processing module, an application-specific integrated circuit (ASIC), or other lower-level components of the SOC 102 itself that are capable of issuing memory requests to the memory controller 130 through the SOC fabric 150.

The client devices 110a-n supply memory requests through the SOC fabric 150 during the course of implementing workloads, with each workload being performed by one or more computing tasks 112a-n. Each computing task can have one or more threads executing on a client device. Hence, the computing tasks and/or threads can be associated with the particular memory requests supplied by the client devices 110a-n.

The example diagram in FIG. 1 illustrates the workload of each client device having computing tasks 112a-n with differing stream ids. In this case, a stream id uniquely identifies a specific computing task. The stream id may be any identifier that distinguishes computing tasks, for example, a universally unique identifier (UUID). Although not depicted in FIG. 1, the threads of each computing task can also have stream ids. Accordingly, one or more stream ids can be included in a memory request that identify the computing tasks (or threads) the memory request belongs to.

The SOC 102, or client devices 110a-n on the SOC 102, can preassign stream ids to particular tasks 112a-n, such that the stream ids are included in memory requests from those tasks. For example, for a GPU client device executing a workload having many threads, each thread can have a separate preassigned stream id. In some implementations, the stream ids assigned to the memory requests of the SOC 102 are based on the type of task that is being performed. As an example, a thread of a GPU that is responsible for texture mapping can be preassigned to have a different stream id than a thread responsible for rendering polygons. As another example, all threads of a TPU operating on the same layer of a neural network may mutually share data. These threads can be associated with a common computing task and preassigned a respective stream id. Other threads operating on different layers can be associated with their own computing tasks and respective stream ids. In this context, a stream id being preassigned means that the stream id was assigned to the computing tasks before the SLC 120 began processing memory requests for the computing task.

More generally, any related set of memory requests can have a corresponding stream id. The stream ids of a memory request can be programmed, preloaded onto the client devices 110a-n, specified by the cache 120 or SOC fabric 150, or dynamically created while servicing memory requests. In some cases, the set of memory requests can include memory requests from multiple client devices that are associated with a respective stream id.

The SOC fabric 150 is a communications subsystem of the SOC 102. The SOC fabric 150 includes communications pathways that allow the client devices 110a-n to communicate with one another as well as to make requests to read and write data using the cache 120 and memory controller 130. The SOC fabric 150 can include any appropriate combination of communications hardware, e.g., buses or dedicated interconnect circuitry.

The system 100 also includes communications pathways that allow communication between the cache 120 and the memory controller 130, communication between the SOC fabric 150 and the memory controller 130, as well as inter-chip communications pathways that allow communication between the memory controller 130 and the memory device 140. In some implementations, the SOC 102 can save power by powering down one or more of the communications pathways. Alternatively or in addition, the SOC 102 can power down the memory device 140 to further conserve power. As another example, the SOC 102 can enter a clock-shut-off mode in which respective clock circuits are powered down for one or more devices.

The cache 120 is positioned in one of the data pathways between the SOC fabric 150 and the memory controller 130. Thus, requests from the client devices 110a-n to read from or write to the memory device 140 pass through the cache 120, or pass directly to the memory controller 130. For example, the client 110a can make a request to read from the memory device 140, which passes through the SOC fabric 150 to the cache 120. The cache 120 can handle the request before forwarding the request to the memory controller 130 for the memory device 140. Alternatively or in addition, the client 110a can make a request to read from the memory device 140, which passes through the SOC fabric 150 directly to the memory controller 130, thus bypassing the cache 120.

The cache 120 can cache read requests, write requests, or both from client devices 110a-n. The cache 120 can cache read requests from client devices 110a-n by responding to the request with data stored in the cache data rather than fetching the data from the memory device 140. Similarly, the cache 120 can cache write requests from client devices 110a-n by writing the new data in the cache rather than writing the new data to the memory device 140. The cache 120 can perform a write-back at a later time to write the updated data to the memory device 140.

The cache 120 can have dedicated cache memory, which can be implemented using dedicated registers or high-speed random access memory. The cache 120 can implement a caching policy that allocates different partitions, e.g., portions, ways, of the cache memory to different respective computing tasks. Therefore, memory requests belonging to the same task can be handled using the same allocated portion of cache memory. For example, the SOC 102 of FIG. 1 illustrates the cache 120 as having a number of allocated partitions 122a-n. Generally, the size (i.e., space in memory) and number of cache partitions 122a-n can be predefined and/or dynamically adjusted while servicing memory requests. In some cases, a subset of the partitions are predefined to reserve space in the cache memory while the remaining memory is dynamically adjustable.

In some implementations, multiple tasks can be allocated the same partition of cache memory. To allocate one or more tasks to a partition, the cache 120 can inspect the stream ids of memory requests to determine which memory requests belong to the same tasks.

One example of these techniques includes allocating different partitions of the cache to different computing tasks executing on the same client device. For example, the cache 120 can inspect the stream ids of incoming memory requests in order to determine that some of the requests relate to processes owned by the first task 112a and that some other requests relate to processes owned by the second task 112b. Thus, in order to prevent these two tasks from competing with each other for cache resources, the cache 120 can allocate a first partition 122a of the cache to the first task 112a executing on the client device 110a and can allocate a second partition 122b of the cache to the second task 112b executing on the same client device 110a. Alternatively or in addition, the first task 112a and/or second task 112b executing on the client device 110a can be allocated no partition, thus bypassing the cache 120.

The cache 120 can also deallocate a computing task from a partition, or swap the task from the partition to a different partition.

Another example includes allocating different partitions 112a-n of the cache 120 to different buffers. For instance, when the SOC 102 is a GPU, each client device can perform a different function in a graphics processing pipeline. Therefore, the different data streams can be identified for render buffers, texture buffers, and vertex buffers, to name just a few examples.

The cache 120 can handle memory requests from the SOC fabric 150 using a controller pipeline. The controller pipeline implements the cache logic for determining whether or not data exists in the cache 120 or needs to be fetched from or written to memory. Thus, the controller pipeline can also provide transactions to the memory controller 130 when access to memory is required, e.g., on a cache miss.

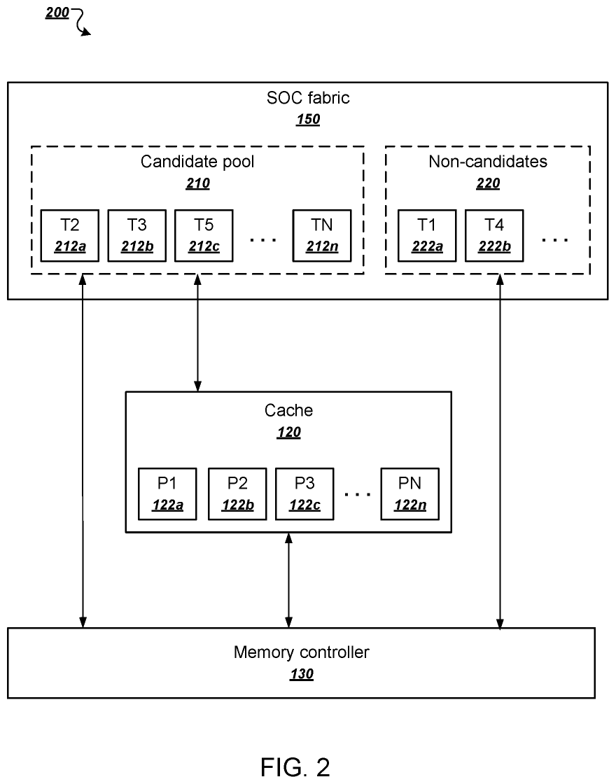

FIG. 2 is a diagram of an example subsystem 200. The subsystem 200 includes a candidate pool 210 that designates a certain set of computing tasks 212a-n based on their respective stream ids. All tasks 222a-n not in the candidate pool 210 are non-candidates 220, which may or may not have stream ids. Although not depicted in FIG. 2, the candidate pool 210 can also include stream ids of different threads of different computing tasks. The candidate pool 210 can include any number of stream ids (e. g, no stream ids, one stream id, two stream ids, etc.) corresponding to any number of tasks. Generally, the candidate pool 210 designates a subset of computing tasks from the total set of computing tasks 112a-n executing on the client devices 110a-n, while the non-candidates 220 correspond to any computing tasks or other memory requests supplied by the client devices 110a-n that are not in the candidate pool 210.

FIG. 2 shows the candidate pool 210 being specified by the SOC fabric 150. However, any appropriate thread or processing device can specify the candidate pool 210.

The candidate pool 210 can be modified in various ways based on various criteria. For example, the SOC fabric 150 can be configured to populate or depopulate the candidate pool 210 with stream ids based on metrics of the cache 120 or main memory. The SOC fabric 150 can also populate the candidate pool 210 with predesignated stream ids at boot time. In some implementations, the candidate pool 210 can be modified by an appropriate algorithm that executes periodically or after some condition is satisfied.

The subsystem 200 shows the candidate pool 210 communicating with the cache 120 and memory controller 130. As mentioned previously, the cache 120 can be partitioned into a number of partitions 122a-n. In this case, only client devices executing computing tasks 212a-n that are designated by the candidate pool 210 can supply memory requests to the cache 120, while all other tasks 222a-n supply memory requests directly to the memory controller 130. Hence, the SOC fabric 150 can use the candidate pool 210 to isolate certain computing tasks 212a-n for optimal utilization of the cache 120. For example, tasks that execute frequently but have predictable and/or limited data usage can be ideal for cache 120 allocation. The SOC fabric 150 can populate the candidate pool 210 with these types of tasks, although in general, the candidate pool 210 can include any computing task.

An allocation engine of the cache 120 can be configured to allocate computing tasks to partitions 122a-n of the cache 120 using the stream ids. For example, the allocation engine can allocate a first partition 112a of the cache for memory requests having a first stream id and a second partition 112b of the cache for memory requests having a second stream id. Accordingly, a cache 120 can identify different computing tasks and allocate different partitions of cache memory to respective tasks based on their respective stream ids. The allocation engine can perform the allocation techniques described below using dedicated hardware circuitry of the cache 120.

Alternatively or in addition, the allocation processes can be implemented in software and the allocation engine can cause a CPU of the host device to perform the allocation algorithm. In some implementations, the allocation process can be executed by a dedicated thread or processing device. The processing device can be integrated into the SOC 102 or into the SOC fabric 150 with the multiple client devices 110a-n.

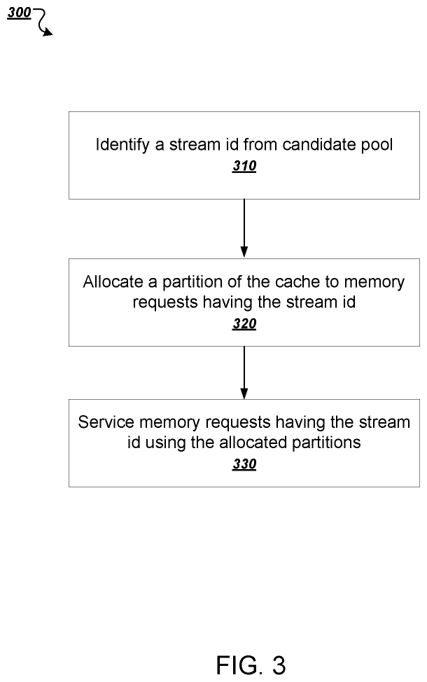

FIG. 3 is a flowchart of an example process 300 for allocating partitions of the cache. The example process 300 can be performed by one or more components of a cache. The example process 300 will be described as being performed by an allocation engine of a cache on an SOC, programmed appropriately in accordance with this specification.

The allocation engine identifies a stream id from a candidate pool of stream ids corresponding to computing tasks (310). As described above, memory requests belonging to particular tasks are assigned associated stream ids. In the example process 300, the allocation engine only identifies stream ids from the candidate pool for allocation.

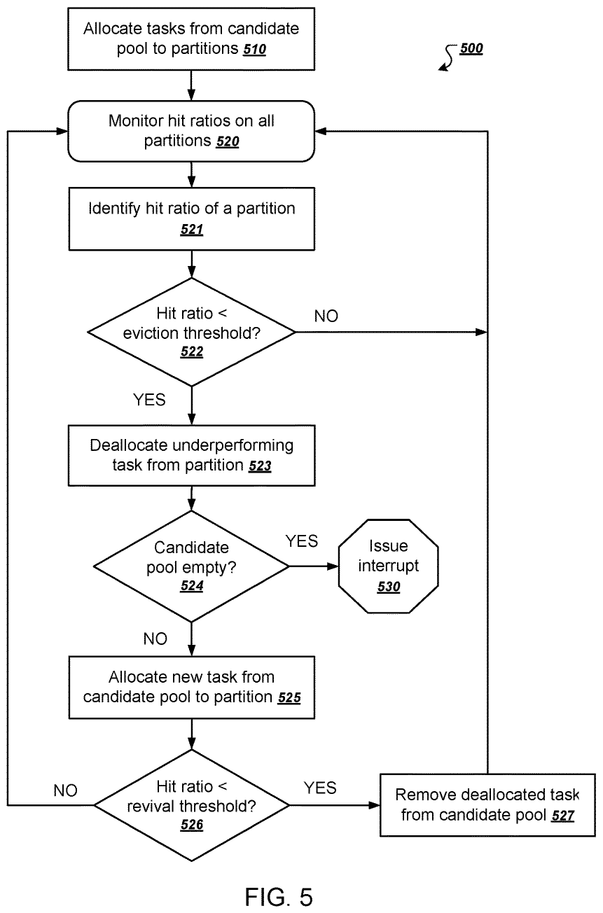

A number of different events can trigger the cache to kick off the allocation process 300 by identifying stream ids of memory requests. For example, the cache can kick off the allocation at boot time. As another example, the SOC can be configured to automatically generate a repartitioning trigger event when the SOC detects execution or usage changes. The trigger event can be a signal or data received through the system that indicates that the candidate pool has been modified and that the partitions of the cache need to be reallocated. Alternatively or in addition, the cache can identify stream ids of memory requests by monitoring memory traffic. For example, the cache can maintain hit metric statistics on all partitions and allocate partitions to stream ids that satisfy certain criteria. FIG. 5, described in detail below, is an example process of adaptively allocating stream ids by monitoring memory traffic and modifying the candidate pool.

A memory request can be associated with more than one stream id, corresponding to more than one computing task. In case of multiple stream ids, the cache can repeat (at least partly) the example process for each of the identified stream ids.

The allocation engine allocates a partition of the cache to memory requests having the stream ids (320). The allocation engine can allocate any appropriate partition of the cache, e.g., one or more lines, sets, ways, or some combination of these. In some implementations, the partitions are exclusively allocated such that only memory requests having the specified stream ids can use the allocated cache resources.

The allocation process can distinguish between different types of computing tasks based on their stream ids. For example, the allocation engine can distinguish tasks representing instructions from tasks representing data and can allocate one partition of the cache to instructions and another portion of the cache to data. Additionally, the allocation engine can distinguish a first computing task executed by a client device from a second computing task executed by the same client device or a different client device and can allocate different partitions of the cache to different computing tasks. Considering a GPU as an example, the allocation process 300 can identify stream ids of texture mapping and polygon rendering threads and allocate different partitions to each respective thread.

In some implementations, the allocation engine can give special priority to tasks with stream ids storing particular types of data structures and can allocate different amounts of cache resources to each. For example, one data buffer that has a substantial impact on caching utilization is the page table. Thus, the allocation engine can treat data buffers storing page table data differently from buffers storing other kinds of data. For example, the allocation engine can allocate 1 MB of cache memory for page table pages and 4 kb of cache memory to other kinds of data buffers.

The cache then services memory requests from client devices on the SOC based on the stream ids of the requests (330). In doing so, the cache can effectively dedicate partitions of the cache to different computing tasks.

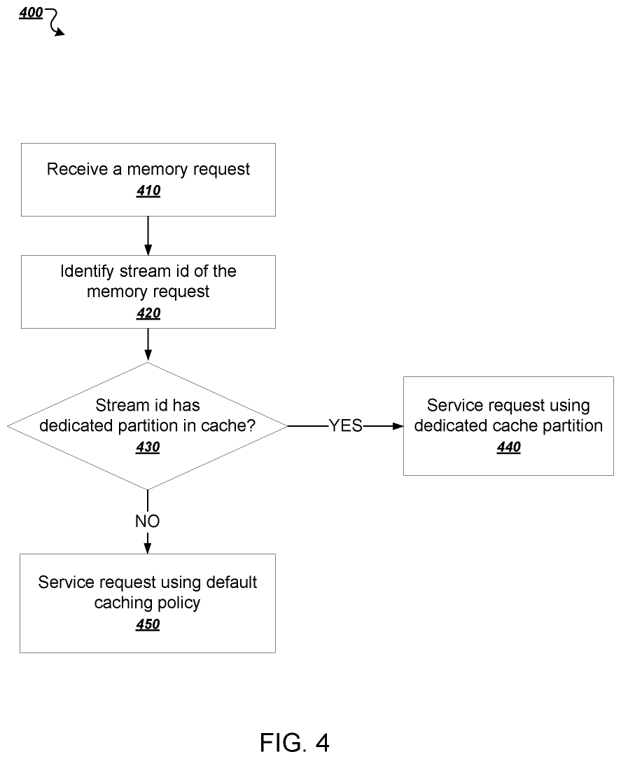

FIG. 4 is a flowchart of an example process 400 for servicing a memory request using partitions of the cache dedicated to computing tasks. The example process can be performed by one or more components of a cache. The example process 400 will be described as being performed by a cache on an SOC, e.g., the cache 120 of FIG. 1.

The cache receives a memory request (410). The memory request can be generated by a particular client device executing a particular computing task.

The cache identifies a stream id of the task associated with the memory request (420). The stream id may belong to a candidate pool and thus may have a dedicated partition.

The cache determines whether the stream id has a dedicated cache partition (430). In response to determining that the stream id has a dedicated cache partition, the cache services the memory request by using the dedicated cache partition (440). Otherwise, the cache services the memory request by using a default caching policy (450).

For example, a memory request for a GPU texture mapping thread can be received (410) by the cache and the stream id identified (420). After determining the stream id has a dedicated cache partition (430), the cache can service the memory request using the partition (440). Likewise, a memory request for a polygon rendering thread of the GPU can be received (410) and the respective stream id identified (420) by the cache. The cache may determine the stream id does not have a dedicated partition (430) and therefore services the memory request using the default caching policy (450).

FIG. 5 is a flowchart of an example process 500 for adaptively allocating computing tasks to partitions of the cache. The example process 500 can be performed by one or more components of a cache and a dedicated thread or processing device configured to perform operations by executing instructions. The processing device can be a client device on the SOC or separately integrated into the SOC. For example, the processing device can be a CPU. In some implementations, the operations of the processing device are performed by the cache.

The cache allocates computing tasks from a candidate pool to cache partitions (510). As mentioned previously with respect to FIG. 3, the cache can allocate tasks from the candidate pool using their respective stream ids. Generally, a subset of tasks from the candidate pool are allocated to the partitions. The cache can allocate the tasks in various ways. The cache can also be instructed by the processing device to allocate the partitions. For example, the cache can be instructed by the processing unit to allocate partitions randomly, based on priority, an algorithm, etc. Multiple computing tasks can also be allocated to a same partition. The cache partitions can be predefined according to some desired memory configuration, which is typically based on the total available memory in the cache. In principle, the partitions can also be dynamically adjusted during the example process 500, although this requires careful cache invalidation.

The processing device monitors hit ratios of all partitions of the cache (520). In the example process 500, the processing device performs operations based on the hit metrics of the cache. However, the processing device can also monitor other performance metrics of the cache, e.g., cache size, associativity, replacement policy, etc

For each partition, the processing device identifies a hit ratio of the partition (521). The processing device can continuously retrieve or calculate per-partition hit ratios on all partitions to identify the particular hit ratio. A per-partition hit ratio is the total number of cache hits divided by the sum of cache hits and cache misses of a particular partition. Generally, the process 500 aims to maximize the hit ratio of all partitions.

The processing device determines if the hit ratio of the partition is lower than an eviction threshold of the partition (522). The eviction threshold specifies a threshold value for the hit ratio and can be a measure of a desired baseline performance for the partition. Note, the eviction threshold can be different for different partitions. The eviction threshold can also change depending on the particular implementation to tune performance of the cache. For example, the eviction threshold can be programmed, specified by the cache 120 or SOC fabric 150, or dynamically created by a caching policy.

If the hit ratio is greater than the eviction threshold, the processing device continues monitoring the hit ratio on all partitions (branch to 520). Hence, the cache maintains task allocations until the processing device determines a hit ratio is less than an eviction threshold on any particular partition.

If the processing device determines the hit ratio is less than the eviction threshold of the partition, the cache deallocates an underperforming task from the partition (523). In some cases, for example, when multiple tasks are allocated to the partition, the cache may deallocate more than one task from the partition.

The processing device determines if the candidate pool is empty (524). In general, the process 500 will continue indefinitely until the candidate pool is empty. At this point, the processing device can perform further operations.

In some implementations, the processing device issues an interrupt and/or warning message (530) if it determines the candidate pool is empty. The warning message can alert a user for further instructions or be issued silently. Alternatively or in addition, the candidate pool can then be repopulated, e.g., by the processing device, based on user instructions or an appropriate algorithm.

On the other hand, if the candidate pool is not empty, the cache allocates a new task from the candidate pool to the partition (525). The cache can select new tasks from the candidate pool in numerous ways. For example, the cache can be instructed by the processing device to select new tasks randomly or based on an algorithm. The algorithm can be round-robin, FIFO (first in first out), based on priority, etc.

After determining the hit ratio of the partition is less than the eviction threshold, the processing device determines if the hit ratio is also less than a revival threshold of the partition (526). The revival threshold specifies a minimum value for the hit ratio of the partition. Again, the revival threshold can be different for different partitions. Similar to the eviction threshold, the revival threshold can also change depending on the particular implementation to tune performance of the cache.

If the processing device determines the hit ratio is less than the revival threshold of the partition, the processing device removes the deallocated computing task from the candidate pool (527). Hence, the removed task cannot be allocated partitions in the cache when the process 500 repeats. That is, after removing the deallocated task from the candidate pool, the processing device continues to monitor the hit ratio on all partitions (520).

On the other hand, if the hit ratio is greater than the eviction threshold, the deallocated task remains in the candidate pool and the processing device continues monitoring the hit ratio on all partitions (branch to 520). Thus, the deallocated task can be reallocated at a subsequent iteration in the process 500.

Consider threads of a GPU as an example, with stream ids of texture mapping and polygon rendering threads in the candidate pool. At the start of the adaptive allocation process 500, the texture mapping thread may be allocated a partition of the cache but not the polygon rendering thread (510). While monitoring hit metrics (520), the process 500 may identify the hit ratio of the texture mapping allocated partition (521) and determine the hit ratio is less than an eviction threshold (522). The process 500 can then deallocate the texture mapping thread from the partition (523). After determining the candidate pool is not empty (524), the process 500 may allocate the polygon rendering thread to the partition (525). Although the hit ratio of the texture mapping allocated partition is less than the eviction threshold, the hit ratio may be greater than a revival threshold (526). In this case, the texture mapping thread remains in the candidate pool and the process 500 repeats by continuing to monitor hit ratios (520). Hence, the total effect for this iteration of the process 500 was to swap the texture mapping thread with the polygon mapping thread for an underperforming partition.

In general, the adaptive allocation process 500 will self-tune to an optimal configuration of computing tasks allocated to the cache partitions, while removing tasks from the candidate pool that tend to perform poorly.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a hardware-implemented or software implemented input/output system that provides an output that is different from the input. An engine can be implemented in dedicated digital circuitry or as computer-readable instructions to be executed by a computing device. Each engine can be implemented within any appropriate type of computing device, e.g., servers, mobile phones, tablet computers, notebook computers, music players, e-book readers, laptop or desktop computers, PDAs, smart phones, or other stationary or portable devices, that includes one or more processing modules and computer-readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a host device having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

In addition to the embodiments described above, the following embodiments are also innovative:
Embodiment 1 is a system comprising:
   a plurality of integrated client devices, each client device configured to generate memory requests, each memory request having a respective pre-assigned stream id that represents a type of computing task to which the memory request belongs; and
   a cache configured to cache memory requests to a memory for each of the plurality of integrated client devices,
   wherein the cache has multiple partitions, and wherein the cache is configured to allocate different partitions to respective memory requests according to stream ids of the memory requests.
Embodiment 2 is the system of embodiment 1, wherein memory requests belonging to different types of computing tasks have different stream ids.
Embodiment 3 is the system of any one of embodiments 1-2, wherein the cache is configured to allocate no partitions to a particular stream id.
Embodiment 4 is the system of any one of embodiments 1-3, wherein the cache is configured to swap a stream id from using a first partition to using a second partition.
Embodiment 5 is the system of any one of embodiments 1-4, wherein the cache is configured to allocate multiple different stream ids to use a same partition.
Embodiment 6 is the system of any one of embodiments 1-5, further comprising a processing device configured to execute instructions to perform operations comprising:
   providing, to the cache, instructions to allocate partitions to stream ids from a candidate pool of stream ids;
   computing per-partition cache hit metrics for each partition; and
   providing, to the cache, instructions to alter partition allocations for one or more stream ids.
Embodiment 7 is the system of embodiment 6, wherein computing the per-partition cache hit metrics comprises computing a hit ratio, and wherein the operations further comprise:
   determining that the hit ratio for a partition is less than an eviction threshold; and
   in response, deallocating one or more stream ids from the partition, and allocating a new stream id, from the candidate pool, to the partition.
Embodiment 8 is the system of embodiment 7, wherein the operations further comprise:
   determining that the hit ratio for the partition is less than a revival threshold; and
   in response, removing the deallocated one or more stream ids from the candidate pool.
Embodiment 9 is the system of any one of embodiments 6-8, wherein the system is configured to allocate, to the partitions, new stream ids from the candidate pool using a selection algorithm based on any one of:
   randomly,
   round-robin,
   first in first out, or
   priority.
Embodiment 10 is the system of any one of embodiments 7-9, wherein the eviction threshold for at least some of the partitions is different.
Embodiment 11 is the system of any one of embodiments 8-10, wherein the revival threshold for at least some of the partitions is different.
Embodiment 12 is a method performed by a device comprising:
   a plurality of integrated client devices, each client device configured to generate memory requests, each memory request having a respective pre-assigned stream id that represents a type of computing task to which the memory request belongs, and
   a cache having multiple partitions,
   the method comprising:
   caching, by the cache, memory requests to a memory for each of the plurality of integrated client devices; and
   allocating, by the cache, different partitions to respective memory requests according to stream ids of the memory requests.
Embodiment 13 is the method of embodiment 12, wherein memory requests belonging to different types of computing tasks have different stream ids.
Embodiment 14 is the method of any one of embodiments 12-13, wherein the cache is configured to allocate no partitions to a particular stream id.
Embodiment 15 is the method of any one of embodiments 12-14, further comprising swapping a stream id from using a first partition to using a second partition.
Embodiment 16 is the method of any one of embodiments 12-15, further comprising allocating multiple different stream ids to use a same partition.
Embodiment 17 is the method of any one of embodiments 12-16, further comprising:
   providing, to the cache, instructions to allocate partitions to stream ids from a candidate pool of stream ids;
   computing per-partition cache hit metrics for each partition; and
   providing, to the cache, instructions to alter partition allocations for one or more stream ids.
Embodiment 18 is the method of embodiment 17, wherein computing the per-partition cache hit metrics comprises computing a hit ratio, and wherein the operations further comprise:
   determining that the hit ratio for a partition is less than an eviction threshold; and
   in response, deallocating one or more stream ids from the partition, and allocating a new stream id, from the candidate pool, to the partition.
Embodiment 19 is the method of embodiment 18, further comprising:
   determining that the hit ratio for the partition is less than a revival threshold; and
   in response, removing the deallocated one or more stream ids from the candidate pool.
Embodiment 20 is the method of any one of embodiments 17-19, further comprising allocating, to the partitions, new stream ids from the candidate pool using a selection algorithm based on any one of:
   randomly,
   round-robin,
   first in first out, or
   priority.
Embodiment 21 is the method of any one of embodiments 18-20, wherein the eviction threshold for at least some of the partitions is different.
Embodiment 22 is the method of any one of embodiments 19-21, wherein the revival threshold for at least some of the partitions is different.
Embodiment 23 is a computer storage medium encoded with a computer program, the program comprising instructions that are operable, when executed by data processing apparatus, to cause the data processing apparatus to perform the method of any one of embodiments 12 to 22.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A system comprising:
a plurality of integrated client devices, each client device configured to generate memory requests, each memory request having a respective pre-assigned stream id that represents a type of computing task to which the memory request belongs; and
a cache configured to cache memory requests to a memory for each of the plurality of integrated client devices,
wherein the cache has multiple partitions, and wherein the cache is configured to allocate different partitions to respective memory requests according to stream ids of the memory requests.

2. The system of claim 1, wherein memory requests belonging to different types of computing tasks have different stream ids.

3. The system of claim 1, wherein the cache is configured to allocate no partitions to a particular stream id.

4. The system of claim 1, wherein the cache is configured to swap a stream id from using a first partition to using a second partition.

5. The system of claim 1, wherein the cache is configured to allocate multiple different stream ids to use a same partition.

6. The system of claim 1, further comprising a processing device configured to execute instructions to perform operations comprising:
providing, to the cache, instructions to allocate partitions to stream ids from a candidate pool of stream ids;
computing per-partition cache hit metrics for each partition; and
providing, to the cache, instructions to alter partition allocations for one or more stream ids.

7. The system of claim 6, wherein computing the per-partition cache hit metrics comprises computing a hit ratio, and wherein the operations further comprise:
determining that the hit ratio for a partition is less than an eviction threshold; and
in response, deallocating one or more stream ids from the partition, and allocating a new stream id, from the candidate pool, to the partition.

8. The system of claim 7, wherein the operations further comprise:
determining that the hit ratio for the partition is less than a revival threshold; and
in response, removing the deallocated one or more stream ids from the candidate pool.

9. The system of claim 6, wherein the system is configured to allocate, to the partitions, new stream ids from the candidate pool using a selection algorithm based on any one of:
randomly,
round-robin,
first in first out, or
priority.

10. The system of claim 7, wherein the eviction threshold for at least some of the partitions is different.

11. The system of claim 8, wherein the revival threshold for at least some of the partitions is different.

12. A method performed by a device comprising:
a plurality of integrated client devices, each client device configured to generate memory requests, each memory request having a respective pre-assigned stream id that represents a type of computing task to which the memory request belongs, and
a cache having multiple partitions,
the method comprising:
caching, by the cache, memory requests to a memory for each of the plurality of integrated client devices; and
allocating, by the cache, different partitions to respective memory requests according to stream ids of the memory requests.

13. The method of claim 12, wherein memory requests belonging to different types of computing tasks have different stream ids.

14. The method of claim 12, wherein the cache is configured to allocate no partitions to a particular stream id.

15. The method of claim 12, further comprising swapping a stream id from using a first partition to using a second partition.

16. The method of claim 12, further comprising allocating multiple different stream ids to use a same partition.

17. The method of claim 12, further comprising:
providing, to the cache, instructions to allocate partitions to stream ids from a candidate pool of stream ids;
computing per-partition cache hit metrics for each partition; and
providing, to the cache, instructions to alter partition allocations for one or more stream ids.

18. The method of claim 17, wherein computing the per-partition cache hit metrics comprises computing a hit ratio, and wherein the operations further comprise:
determining that the hit ratio for a partition is less than an eviction threshold; and
in response, deallocating one or more stream ids from the partition, and allocating a new stream id, from the candidate pool, to the partition.

19. The method of claim 18, further comprising:
determining that the hit ratio for the partition is less than a revival threshold; and
in response, removing the deallocated one or more stream ids from the candidate pool.

20. The method of claim 17, further comprising allocating, to the partitions, new stream ids from the candidate pool using a selection algorithm based on any one of:
randomly,
round-robin,
first in first out, or
priority.

21. The method of claim 18, wherein the eviction threshold for at least some of the partitions is different.

22. The method of claim 19, wherein the revival threshold for at least some of the partitions is different.
